(19) United States
(12) Patent Application Publication
(10) Pub. No.: US 2024/0291320 A1
(43) Pub. Date: Aug. 29, 2024

(54) CONTROL OF DC/DC-LESS WIRELESS CHARGER TRANSMITTERS IN EMC SENSITIVE ENVIRONMENT

(71) Applicant: SHANGHAI SQUARE PLUS INFORMATION TECHNOLOGY CONSULTING LTD., Shanghai (CN)

(72) Inventor: Stephane SCHULER, Shanghai (CN)

(73) Assignee: SHANGHAI SQUARE PLUS INFORMATION TECHNOLOGY CONSULTING LTD., Shanghai (CN)

(21) Appl. No.: 18/573,344

(22) PCT Filed: Jun. 24, 2021
(86) PCT No.: PCT/CN2021/101958

§ 371 Date: Dec. 21, 2023

(51) Int. Cl. H02J 50/10; H02J 7/00; H02J 50/70; H02J 50/80

(52) U.S. Cl. CPC H02J 50/10; H02J 7/0071; H02J 50/70; H02J 50/80

(57) ABSTRACT

A charging controller for a wireless charging transmitter, wherein the charging controller comprises a voltage inverter with output terminals electrically connectable to an inductive wireless charging antenna and configurable to operate the voltage inverter a nominal switching frequency, fₒₚ. The nominal switching frequency has an associated period, Tₒₚ. The charging controller is configured to supply to the output terminals a frame comprising at least two periods. In the first period, the controller is configured to supply a first sequence, S_{A}, and in the second period, the controller is configured to supply a second sequence, S_{B}. he first sequence, S_{A}, is different from the second sequence, S_{B}.

### FIELD OF INVENTION

The field of the invention is wireless charging devices.

### BACKGROUND OF INVENTION

Wireless charging applications for smartphones are increasingly popular, mostly for the convenience they offer. In an automotive context, wireless charging transmitters enhance safety by providing a repository for the driver's phone, reducing driver distraction (most countries around the world are prohibiting smartphone usage while driving) and avoiding the need for charger cords that may present a danger of becoming entangled with the vehicle controls.

Additionally, many automobile makers are nowadays considering the wireless charger repository as a hub for close range interactions between the smartphone and the vehicle. One can mention here Near Field Communication (NFC) or a Long Term Evolution (LTE) coupler.

Several wireless charging methods have been proposed. However, only the Wireless Power Consortium (WPC) with the Qi standard has been widely accepted and embedded by the smartphone makers, making it the de-facto wireless charging standard. The Qi standard was originally engineered for consumer electronics applications, allowing smartphone makers to develop their private charging ecosystem.

On the other hand, the wireless charger system proliferation is negatively impacted by two factors:
Wireless charger transmitters are more complex than standard USB chargers primarily leading to significantly higher cost of material and consequently higher sales prices.
Wireless charger systems' efficiency is significantly lower than standard USB chargers causing advert heating consequences that can't, for proper system operation, be left unmitigated, further increasing the cost of material.

Returning to the automotive context, embedding a Qi standard transmitter application in a vehicle environment has proved challenging. Most of the design proposed by the Qi standard are unsuited to vehicle integration: by nature, the Qi operating frequency (in the 100˜140 kHz range) is jamming the close by AM-Band (560˜1600 kHz) radio that is still in use in many countries, for example in Germany, where it is used for traffic information broadcasting.

To prevent the AM-Band jamming, a MP-A13 antenna transmitter has been certified by the WPC within its Qi standard. This construction implements filters that drag additional efficiency losses, besides the costs for the filter themselves.

The efficiency loss causes heat generation that in turn causes the smartphone repository to heat up, undermining the charging operation. The heating up is usually mitigated by embedding an active cooling system in the wireless charging transmitter that is aimed at cooling the wireless charging transmitter and the in-charge device, which temperature has to be kept below 40 deg C. to protect its battery.

### SUMMARY OF INVENTION

According to a first aspect, there is provided a charging controller for a wireless charging transmitter. The charging controller comprises a voltage inverter with output terminals electrically connectable to an inductive wireless charging antenna and configurable to operate the voltage inverter at a nominal switching frequency, fₒₚ. The nominal switching frequency has an associated period, Tₒₚ. The charging controller is configured to supply to the output terminals a frame comprising at least two periods. In the first period the controller is configured to supply a first sequence, S_{A}, and in the second period, the controller is configured to supply a second sequence, S_{S}. The first sequence, S_{A}, is different from the second sequence, S_{B}.

In an embodiment, the frame comprises K periods, Tₒₚ, K being an integer greater than 1, and the charging controller is configured to supply, for each of the respective K periods a respective sequence, S_{A}, or, S_{B}.

In an embodiment, the respective sequences are selected from a predefined set of M sequences, wherein M is less than or equal to K.

In an embodiment, the sequences are selected from a look-up table.

In an embodiment, the charging controller is further configured to: receive a target power level, and select from the look-up table the first sequence, S_{A}, and the second sequence, S_{B}, the sequences being selected such that the target power level is in a range between a power level associated with a first power level of the first sequence S_{A} and a second power level of the second sequence S_{B}. The sequences are selected from amongst the sequences in the look-up table. The controller is further configured to select a respective count for each of the sequences, such that a sum of the product of each of the sequences' power levels and its respective count is equal to a power level within the range.

In an embodiment, the first closest sequence, S_{A}, is a sequence from a plurality of sequences in the look-up table with a power level closest to the target power.

In an embodiment, the plurality of sequences consists of the first and second closest sequences S_{A} and S_{B}.

In an embodiment, the second closest sequence, S_{B}, is a sequence from the plurality of sequences in the look-up table with a power level second closest to the target power.

In an embodiment, the lookup table lists sequences sorted by a fundamental frequency, fₒₚ, power.

In an embodiment, the selected sequences are characterized by a spectral signature equivalent to a square wave spectral signature of a same fundamental frequency, fₒₚ, with harmonics attenuated in the AM-band.

In an embodiment, the voltage inverter driver further comprises a microcontroller for controlling a wireless charging operation by controlling the voltage inverter based on the received data from a target device through an amplitude demodulator circuit.

In an embodiment, the charging controller is further comprising a DC-DC converter, configured to receive power from the DC power source at a first voltage and provide power to the voltage inverter at a second voltage, the second voltage being higher than the first voltage.

According to a second aspect, there is provided a method of operating a charging controller according to the first aspect. The method comprises supplying to the output terminals a frame comprising at least two periods, a first sequence, S_{A}, in a first period, Tₒₚ, and a second sequence, S_{B}, in a second period, Tₒₚ, the first sequence, S_{A}, being different from the second sequence, S_{B}.

In an embodiment, the method comprises receiving a target power level, and selecting from the look-up table: a first closest sequence, S_{A}, and a second closest sequence, S_{B}. The target power level is in a range between a power level associated with a first power level of the first closest sequence S_{A} and a second power level of the second closest sequence S₈.

The method further comprises selecting a plurality of sequences from amongst the sequences in the look-up table, and selecting a respective count for each of the plurality of sequences, such that a sum of the product of each of the sequences' power levels and its respective count is equal to a power level within the range.

According to a third aspect, there is provided a wireless charging transmitter comprising a charging system according to the first aspect, further comprising an inductive wireless charging antenna electrically connected to the output terminals of the voltage inverter, and a DC power source to supply the voltage inverter Driver.

In an embodiment, the wireless charging transmitter further comprises a low-pass or band-rejection filter installed between the voltage inverter and the inductive wireless charging antenna, and a power line filter installed downstream the DC power source.

### BRIEF DESCRIPTION OF DRAWINGS AND GRAPHS

Embodiments will now be described with reference to the drawings, in which:

FIG. 1A is a functional diagram of current state of the art solutions that have been certified by the Wireless Power Consortium;

FIG. 1B is a flowchart illustrating a method of regulating the wireless transmission power in the state of the art configurations of FIG. 1A;

FIG. 1C is a functional diagram highlighting the power transmission regulation loop in the state of the art system;

FIGS. 2A and 2B are time and frequency signal analysis of the antenna power feed signal as used in the current state of the art solutions;

FIGS. 2C and 2D are time and frequency signal analysis assuming a pulse width modulated (PWM) antenna power feed signal;

FIGS. 3A and 3B are graphs illustrating examples of sequential signal organizations according to embodiments;

FIG. 3C is an example of a lookup table of pulse width modulated sequences of length 24 bits;

FIG. 4A is a diagram illustrating the definition of a pulse width modulated sequence;

FIGS. 4B and 4C are diagrams illustrating the definition of a frame of sequences as proposed by this disclosure, with FIG. 4B being the minimum size of the frame and FIG. 4C being a generalization of the frame concept;

FIGS. 4D and 4E are illustrating the linearization process that takes place when using frames. FIG. 4D is a simple linearisation method using a single scale and FIG. 4E is a more complex method using 2 scales but relaxing the requirements on the selected sequences;

FIGS. 4F and 4G are signal diagrams showing how to measure the maximum frequency of a pulse width modulated sequence: FIG. 4F relates to a ‘positive’ 010 bit sequence and FIG. 4G to a ‘negative’ 101 bit sequence;

FIG. 5A is a functional diagrams illustrating a wireless charging device and controller according to embodiments;

FIG. 5B is a flowchart illustrating a method of regulating the wireless transmission power according to this disclosure;

FIG. 5C is a functional diagram highlighting the power transmission regulation loop according to this disclosure;

FIG. 5D is a flowchart representing the frame construction process;

FIG. 6A is a schematic diagram illustrating electronic circuits that generate the pulse width modulated sequences embedded in the circuits of FIG. 5A;

FIGS. 6B and 6C are part schematic and part graphical diagrams illustrating two configuration options to control the H-bridge switches according to embodiments.

### DETAILED DESCRIPTION

Embodiments of the present disclosure are described below in details with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill of the art that the invention is not limited to these embodiments, rather, the invention is defined by the claims. In other instances, well-known features have not been described in detail to avoid unnecessarily complicating the description.

Those skilled in the art would appreciate how the term motor vehicle hereafter may be understood to be a truck, a car, a sport utility vehicle or a suburban utility vehicle (SUV), or any known automobile in the art. As used herein, the term “coupled” or “coupled to, “openable to” or “operatively connected to,” or “connected” or “connected to” may indicate establishing either a direct or indirect connection and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification.

In general, the invention relates to a wireless charging transmitter working according to the Qi standard released by the Wireless Power Consortium but a person skilled in the art would appreciate the invention may be adapted to other systems not compliant with the standard.

USB chargers are significantly cheaper to build than wireless chargers. Additionally, they also feature better performances in terms of efficiency and charging durations, which is the end user main performance indicator besides the acquisition costs. From that perspective, a more complex and costly wireless charging transmitter without additional benefits is understandably not attractive. It is nowadays considered a main brake to the system's market proliferation.

Further complexity occurs when the wireless charger is installed in a vehicle. The wireless charging transmitter is usually integrated between the two front seats of a vehicle, a location where it can interfere electromagnetically with other applications and functions of the vehicle embedded in its vicinity. A well-documented interference is the jamming of the AM-Band radio by the harmonics of the wireless charging signal. This problem is acute for the high power chargers (>5 W) that are needed to satisfy an end user demand for short charging durations.

With the operating frequency of the wireless charger being close to the AM radio band, interference with it is hardly avoidable. One solution that has been proposed is to filter the wireless charger antenna feed signal harmonics by an analogue filter. It is referenced MP-A13 in the Wireless consortium Qi standard. In automotive applications, additional filters are required on the power lines to prevent conducting noise on the DC power lines. These filters enable the jamming of the AM band radio to be prevented.

However, the implementation of the filters and in particular the one filtering the wireless charger antenna feed signal brings with it some drawbacks that need to be mitigated, further adding cost, inefficiency and complexity to the wireless charging transmitter:
To be efficient against radiation, the filter needs to be of a high order. The MP-A13 solution proposes a π-shaped filter using inductances and high temperature stability ceramic capacitances. Selecting the inductance is a challenge in itself with no power inductors having been designed for the particular purpose of a power filter.
Due to its location, between the voltage inverter and the wireless charging antenna, the filter dissipates a significant portion of the signal power. Most of this energy is converted into heat, raising the filter inductors' temperature significantly. Instead of being broadcasted, the feed signal harmonics are now converted into heat, negatively affecting the charging efficiency at the same time.
Heat is generally a concern when designing a wireless charging transmitter. When charging wirelessly or with a cord, the in-charge device is constantly monitoring its battery temperature. This is necessary to protect the Lithium-ion batteries in particular. This type of battery is very sensitive to high temperature, affecting safety both while charging and in terms of long term reliability. If left unmanaged, overheating will result in extended charging durations which conflicts with the original demand of end users for shorter charging duration.

While state of the art solutions propose fixes with mitigations, this invention proposes a new solution primarily based on improving the wireless transmitter efficiency by redefining the wireless transmitter antenna feed signal. The aim is to relocate the transmission power regulation function to the voltage inverter and to cancel the need for EMC filters in automotive applications. This has the following effects:
In applications using DC power sources between 9 and 16 volt, a voltage controlled output DC-DC converter is no longer needed, providing a net efficiency gain of roughly 5 to 8% in addition to its cost saving.
Depending on the application and level of EMC emissions required, filters may no longer be needed at all, or, if they are, they can be significantly reduced in size. This provides for another net efficiency gain of 5 to 7% coupled with a significant cost reduction. Furthermore, the lower resulting temperature elevation of the wireless transmitter enables simpler active cooling systems, further reducing inefficiency and costs.

Embodiments of the invention are directed to the definition and generation of a power feed signal for a wireless charging antenna with the purposes of:
regulating the transmission power;
minimizing the electromagnetic radiated and conducted emissions; and
improving the wireless charging transmitter efficiency thus reducing the heat losses of the wireless charging transmitter unit

Hence the invention provides a more efficient, electromagnetically quieter, smaller sized and cheaper wireless charging transmitter unit which is easier to embed in strictly constrained environments such as in motor vehicles.

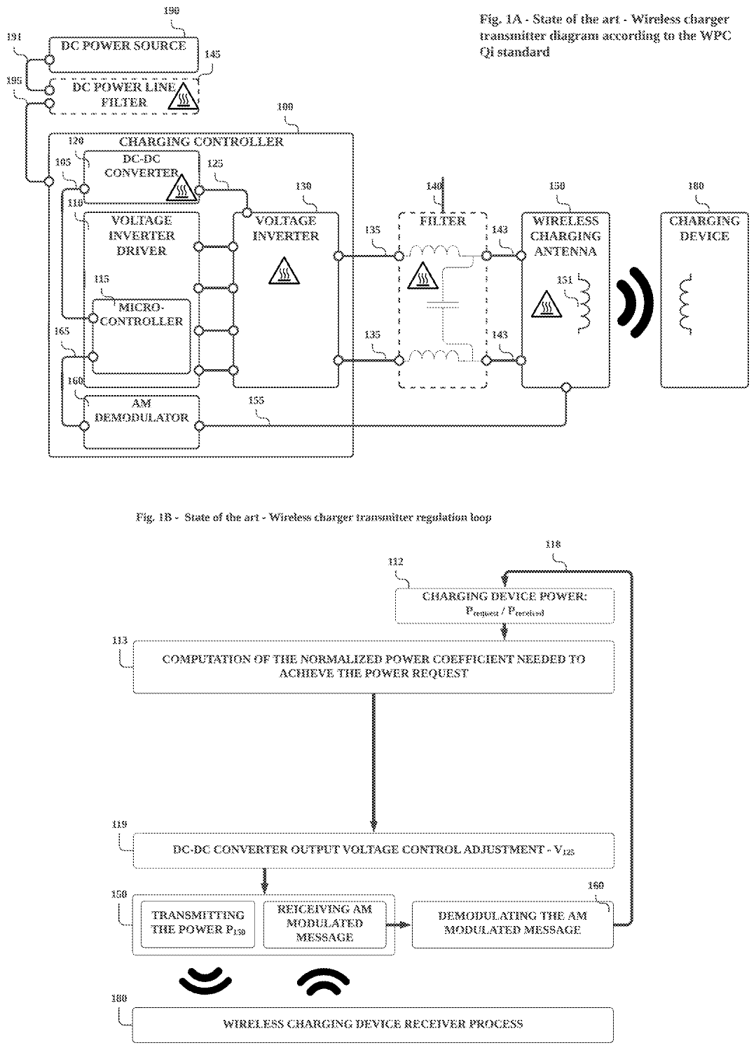

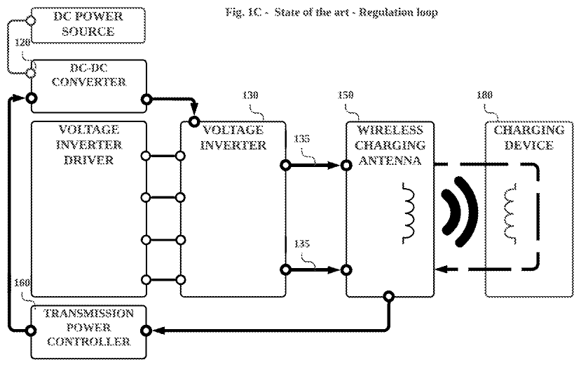

FIG. 1A is a functional diagram which describes a current state of the art solution that is certified by the Wireless Power Consortium within its Qi standard.

For simplification purposes, some functions (mostly monitoring) have been omitted from the description and figures. In many cases, these functions will have to be carried over the way they are in the state of the art solutions. However, for some topologies, the absence of filters may present some opportunities for safety improvement.

FIG. 1A only shows a single charging antenna for simplification purposes. However, many systems use three or more charging antennas that are selected through a multiplexer. The multiplexer has been omitted for simplicity.

The DC power source 190 is not considered part of the wireless charging system since it is dependent on the environment (for example 12V for most automotive applications).

FIG. 1A is a functional diagram illustrating the basic components needed to build a wireless charging function. From a high level perspective, a wireless charger transmitter can been made of 2 main functional blocks, namely:
A charging controller 100 which manages all aspects of the wireless power transfer, implementing the Wireless Consortium Qi standard.
A wireless charging antenna 150 which comprises at least one radiating coil 151 coupled serially to a capacitance (not represented). The serial inductance 151 and coupled capacitance implement a low-pass filter, for which the cut-off frequency f_{c} is typically set just below 100 kHz. As such the wireless charging antenna is a major source of inefficiency.

The charging controller 100 block is further broken down in 4 sub-block:
A voltage inverter driver 110 itself is embedding a microcontroller 115 which executes a firmware code implementing the Wireless Consortium Qi standard and interfaces to and from the other sublocks of the controller 100 and the wireless charging antenna 150.
A voltage inverter 130, which converts the power supply DC output voltage 125 into an AC square signal 135 which is used to feed the wireless charging antenna 150. Usually, the voltage inverter 130 is an H-bridge topology inverter made of four switches, typically power MOSFETs that are controlled by the voltage inverter driver 110. A nominal operating frequency fₒₚ is defined in accordance with the Qi standard. This operating frequency fₒₚ is typically in the range of 100 to 140 kHz. According to the Qi standard, from version 1.3 onwards, the voltage inverter 130 is further controlled to superimpose a Frequency Shift Keying (FSK) modulation used for digital communication towards the in-charge device 180. The voltage inverter 130 contributes to the system inefficiency through switching losses.
A DC-DC converter 120 which converts a DC input voltage 195 from the DC power source 190 into the DC output voltage 125 needed to provide the requested power by the in-charge device (a smartphone for example). The DC output voltage 125 is controlled by the voltage inverter driver 110. The control method of the DC output voltage 125 can be either directly through a Pulse width modulation signal (PWM) or any digital communication 105 between the voltage inverter driver and the DC-DC converter 120. The DC-DC converter 120 can be a Buck or Buck-Boost topology, depending on requirements. Like all power supplies, the DC-DC converter 120 is also causing inefficiency.
An Amplitude Modulation (AM) demodulator 160 which demodulates the signal received from the in-charge device 180 through load modulation according to the Qi standard and feeds it back to the microcontroller 115 of the voltage inverter driver 110, thus closing the charging regulation loop. This demodulation is typically implemented by a simple low-pass envelope detector that is read by the microcontroller 115 through an input capture port 165.

Automotive wireless transmitters usually feature two additional filter functions represented in dotted lines:
In order to mitigate this interference, the Wireless Power Consortium has proposed the solution involving the insertion of a low-pass filter 140 between the voltage inverter 130 and the wireless charging antenna 150. Its primary purpose is to attenuate the interference potential of the voltage inverter 130 output AC signal 135 harmonics above the operating frequency fₒₚ. This filter is a major contributor of inefficiency due to its low cut frequency f_{c}.
A power line filter 145 is provided upstream of the DC-DC converter 120. Its purpose is to reduce the conduction of interferences from the voltage inverter 130 along the wireless charger transmitter power supply lines. This filter usually comprises a power choke combined with one or more inductors to create a low-pass filter. The power line filter 145 may not be needed for consumer market wireless charger transmitters. In automotive applications, however, it is mandatory to prevent interference from radiating through the vehicle wire harness. This filter is a minor inefficiency through its resistive characteristic.

Nowadays, many wireless charging transmitters makers select the frequency fₒₚ at 127.7 kHz, a frequency that offers additional benefits that are well known by persons skilled in the art.

For simplification purposes, this frequency fₒₚ has been used as a baseline for all graphs of this disclosure. The invention, however, is not limited to this particular frequency fₒₚ.

FIG. 1B is a flowchart illustrating the power regulation process of the wireless charging transmitter executed by the microcontroller 115. Only the steps relevant to the regulation loop are described. For clarity, the essential functions performed by hardware have been left with their corresponding reference of FIG. 1A. The method comprises:
Obtaining, as per the Qi Standard, the requested power P_{reqest} and the received power P_{received} from the in charge target device by extracting relevant data from the demodulated signal received from the in-charge device at step 112.
Computing at step 113, a DC-DC output voltage V₁₂₅ using standard electrical circuit calculations. This step may be as simple as:

$$\begin{matrix}( For FIG . 1 A configuration ) & \\ {V}_{125} = \frac{{P}_{150}}{{I}_{150}} & Equation 1\end{matrix}$$

Computing at step 119, the pulse width modulation signal or the command required to adjust the output voltage V₁₂₅ of the DC-DC converter 120.
Radiating by the wireless charger transmitter the power P₁₅₀ through the wireless charging antenna 150.
Measuring by the in-charge device the received Power P_{received} and broadcasting it back to the transmitter through load modulation.
Demodulating the received message by the AM demodulator 160 and returning to step 112, thus closing the regulation loop.
Responding to the transmitter by accordingly either increasing, decreasing or keeping the same power transmission settings by adjusting the output voltage V₁₂₅ of the DC-DC converter 120.

FIG. 1C shows the transmission power regulation loop in the state of the art system. While the process has been described in FIG. 1B, FIG. 1C shows the loop at the functional level using bolded arrows. In the state of the art process, the voltage inverter input voltage is the parameter used to regulate the transmission power: this task is implemented by the DC-DC converter 120.

After initialization of the communication between the wireless charging transmitter and the in-charge device 180, the in-charge device 180 acts as the master by sending back the received and requested power in a load modulated message (Qi standard). The wireless charger demodulates the message and adjusts the DC-DC converter 120 output voltage. The voltage inverter 130 and the antenna 150 are passive in the process: they introduce some losses that are to be compensated by increasing the DC-DC converter 120 output voltage. The wireless charging antenna 150 radiates the power that is partially received and measured by the in-charge device 180, closing the regulation loop.

Previous disclosures propose changing the voltage inverter 130 output signal 135 to mitigate the radiation effect sufficiently to eliminate the needs for the filters 140 and 145 in automotive applications and to transfer the power regulation function done by the output voltage controlled DC-DC converter 120 to the voltage inverter 130.

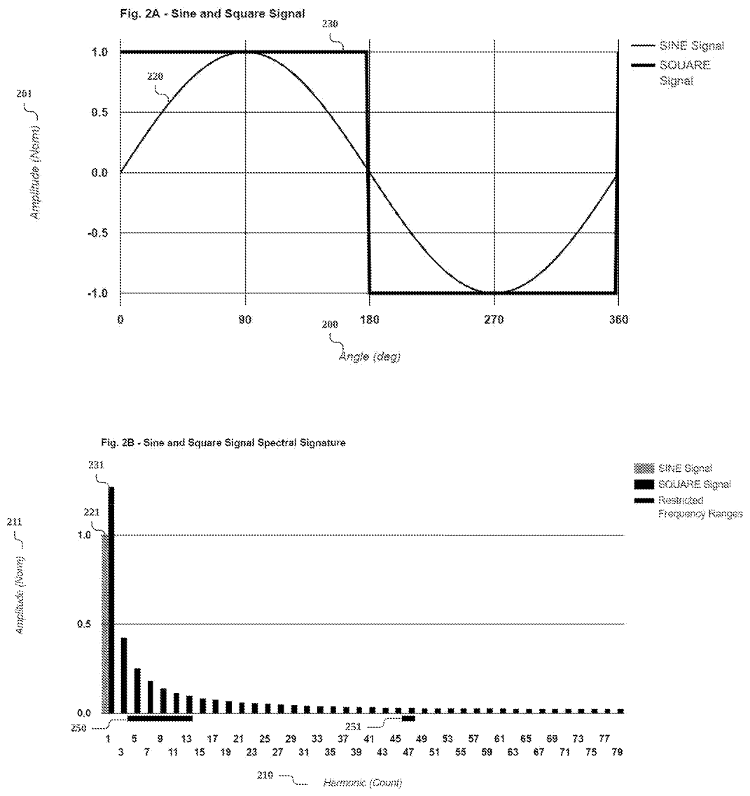

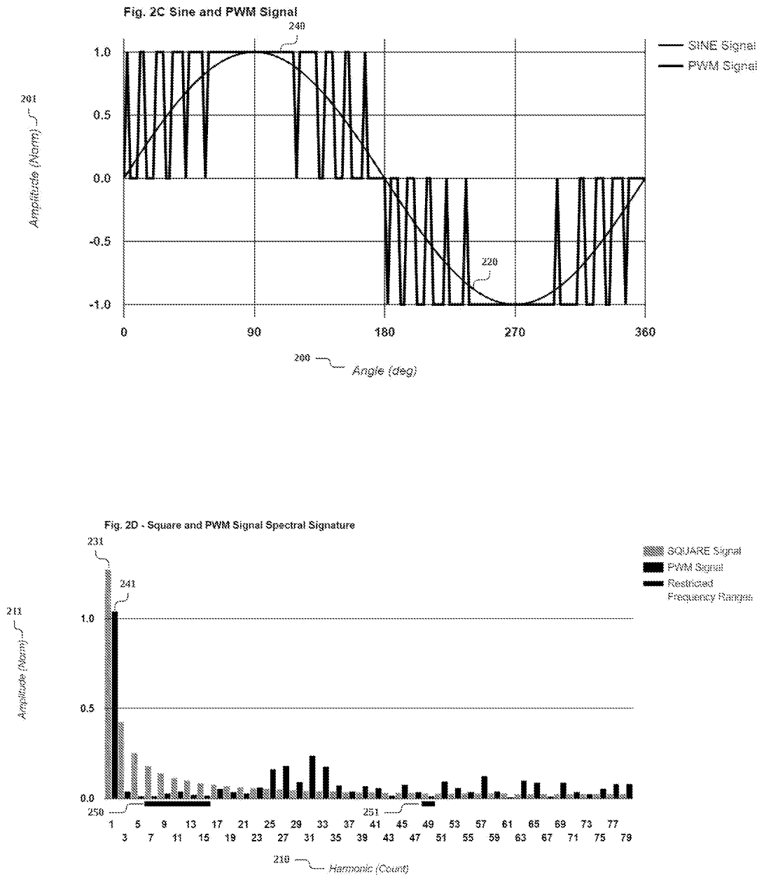

FIG. 2A is a graph illustrating the temporal response of the voltage inverter AC signal output 135 as used by the state of the art solutions illustrated in FIG. 1A, and described above. The voltage inverter 130 is controlled so as to generate a square signal 230. For comparison purposes, a pure sinusoidal signal 220 with the same amplitude has been illustrated as well.

FIG. 2B is the spectral signature of the square signal 230. The pure sinusoidal signal 220 spectral signature has been represented as well for reference purposes.

As can be seen in FIG. 2B:
the energy carried by the operation frequency fₒₚ of the square signal exceeds the energy carried by the sinusoidal signal by almost 30%.
interferences from the square signal spectral signature 231 with the MW radio band are to be expected at harmonics 5, 7, 9, 11 and 13 and interference with the SW radio band at harmonic 47 for an operation frequency fₒₚ of 127.7 kHz. Should the operation frequency fₒₚ be below 112 kHz, the interfering harmonics would be 7, 9, 11, 13 and 15.

Measurements taken at 15 W charging power confirm a level of radiation in excess of 12 to 18 dBpV/m over the class 5 limits that are defined by the CISPR25 standard used for automotive applications. In the countries where the AM radio band is in use, these interferences are not considered to be acceptable. In Germany, for example, this interference would jam traffic information broadcasted on the AM radio band.

In order to mitigate this interference, the Wireless Power Consortium has proposed the solution involving the low-pass filter 140. However, with an operation frequency fₒₚ very close to the MW radio band 250 starting frequency of 560 kHz, designing an analogue filter with sufficient attenuation is very challenging. Its cut-off frequency f_{c} is to be chosen close to the operating frequency fₒₚ and with an attenuation factor high enough to sufficiently dampen the harmonic 5. Practically this can be achieved using a so-called π-shaped LC filter. However, experience teaches that a low-pass filter 140 insertion may attenuate harmonic 5 just enough for 15 W charging power, practically limiting the power of wireless charging transmitters in the automotive environment. This causes a problem as the market, particularly in Asia, is pushing towards higher charging powers,

Besides this power limitation, the low-pass filter 140 brings further technical problems:
Part of the voltage inverter AC output signal 135 energy, which was previously radiated, is turned into heat, creating new constraints on the wireless charging system.
As a consequence of this heating, the efficiency of the wireless charging transmitter is further reduced.

Generating the very convenient sine signal 220 out of a DC supply can be realized in a number of ways. However, for power signals, this is not an easy task. While most of the known techniques work well for low power signals, only a few are suitable for generating energy carrying signals without causing extensive losses. The losses generate effects that we are trying to minimize, namely: thermal losses generated during the signal conversions.

As discussed above, the temperature elevation of the wireless charger transmitter has to be dissipated to minimize thermal conduction by contact to the in-charge device 180. For safe operation, Lithium-ion batteries must not be charged at temperatures over 40 deg C. When the battery temperature reaches the maximum allowed level, most wireless charging receivers are programmed to lower the energy transfer to regulate the battery temperature, resulting in extended charging times.

In order to reduce radiation without introducing a significant loss, embodiments of the present invention provide a voltage inverter AC output signal 135 that mimics a sine or a trapezoid signal by using the properties of a Pulse Width Modulation signal 240 as shown in FIG. 2C. The definition of the Pulse Width Modulation signal 240 is given as an example among many others: the spectral signature of the signal and its carried energy can be adjusted by altering the pulse durations and phases.

FIG. 2D is a comparative representation of the spectral signature of the square signal 230 and the Pulse Width Modulated signal 240. The Pulse Width Modulated signal, while conveniently attenuating low frequency harmonics in the AM-Band range, also amplifies higher level harmonics. These higher level harmonics are to be expected since the Pulse Width Modulation signal 240 of FIG. 2C involves switching the voltage inverter 130 at a higher frequency f_{sw} than the frequency fₒₚ.

The Pulse Width Modulation signal 240 of FIG. 2C is implemented with a frequency f_{sw} that is a N times multiple of the frequency fₒₚ. In the example of FIG. 2C, N has been chosen equal to 160: it provides a discrete voltage inverter AC output signal 135 in 160 shorter signals of 160 times the frequency fₒₚ.

While the maximum switching frequency f_{sw} of a Pulse Width Modulation signal is in direct linear relationship with N, the average switching frequency f_{swa} mostly depends on the sequence definition S₁₃₅ and the number of times the signal changes from off to on and on to off within the a full cycle of the operation frequency fₒₚ. For efficiency consideration, both the maximum switching frequency f_{sw} and the average switching frequency f_{swa} are to be taken into account, the later being predominant.

Changing the durations and phases of the Pulse Width Modulation signal 240, practically by changing the bit setting of the N length sequence allows:
control of the power to be transferred to the in-charge device 180.
mitigation of the effect of harmonics to avoid AM-band radio interferences.

The Pulse Width Modulated signal definition is characterized by a bit sequence S₁₃₅ of length N. Bits equal to zero are disconnecting the wireless charging antenna 150 from the power source, while bits equal to one are connecting the wireless charging antenna 150 to a positive polarity during the first half period of the signal and the opposite polarity during the second half period of the signal.

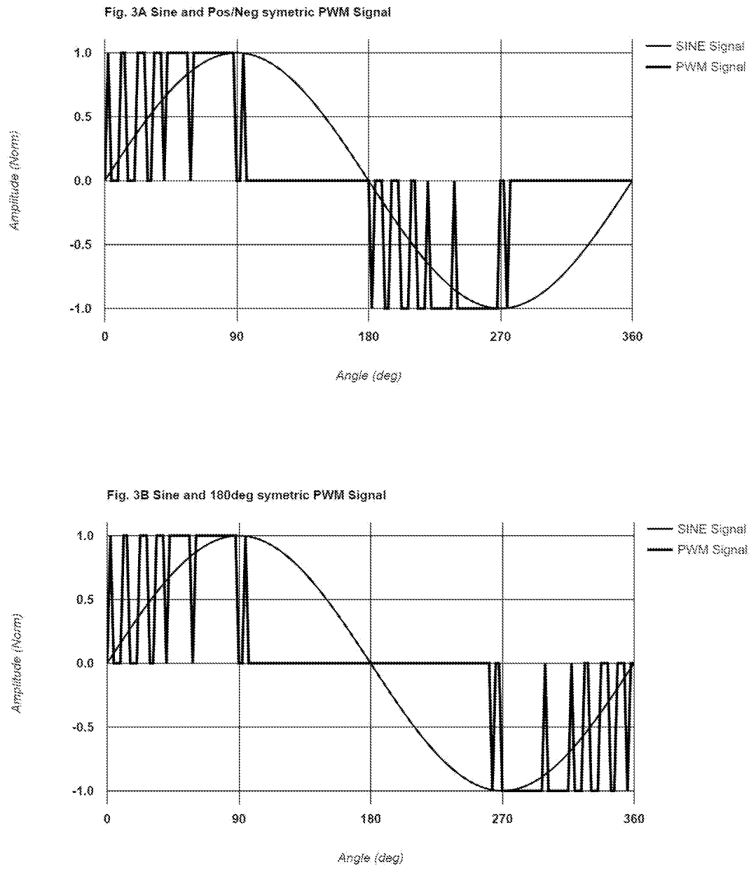

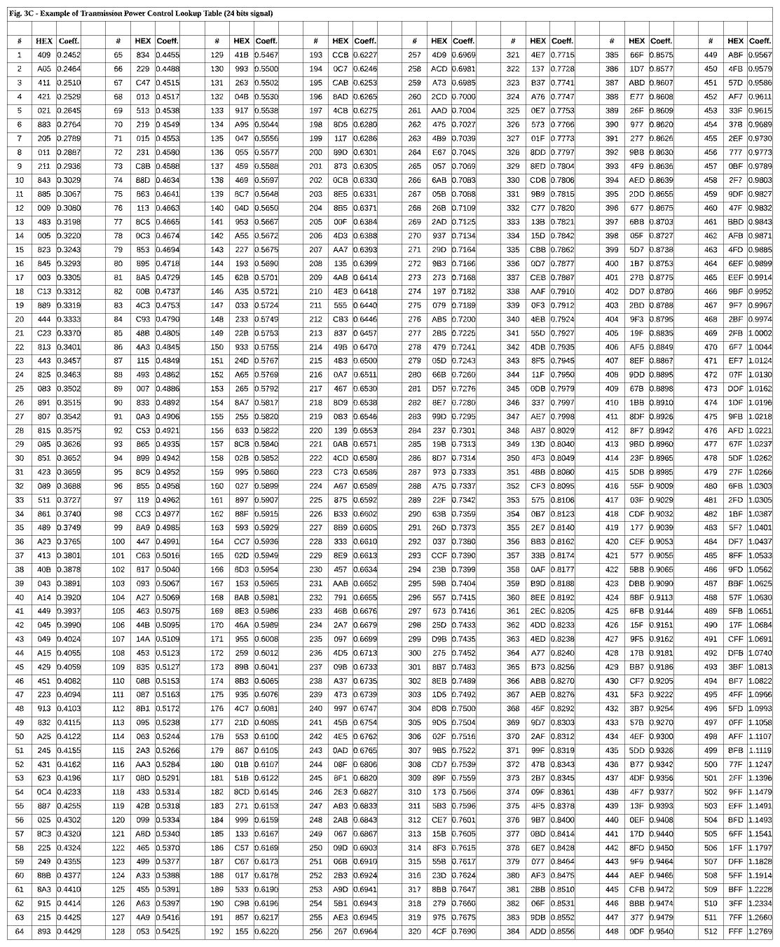

The organization of the Pulse Width modulation sequence S₁₃₅ can be implemented in several ways. Many of these ways result in creating a DC component in the frequency signature of the signal, thus making them unsuitable. The DC component may be fully filtered by either the wireless charging antenna 150 or the low-pass filter 140 when the latter is present. This leaves two sequence organizations suitable. These are represented in FIGS. 3A and 3B. In FIGS. 3A and 3B, the sequences have been simplified for visual description clarity.

FIG. 3A is a graph representing a signal that is positive/negative symmetrical and that generates only the odd frequency harmonics. This signal is generated by driving the voltage inverter 130 with the same signal definition during the positive half period [0,π] and the negative half period [π,2π].

FIG. 3B is a graph representing a signal that is π symmetrical. This signal frequency signature displays both even and odd harmonics. FIG. 3B type of signal can be generated by reverse sequencing the signal definition driving the voltage inverter 130 in the [0,π] time frame to drive the voltage inverter during the second half period [π,2π]. The signal of FIG. 3B can be of interest since it allows further spreading of the energy along the even harmonics.

Regardless of the size of N, each sequence S₁₃₅ definition carries a unique spectral signature that allows 2 relevant classifications for the wireless charger operation:
the sequence power is mostly carried by the fundamental (harmonic 1) frequency fₒₚ, in the case of the wireless charging transmitter, the wireless charging antenna 150 eventually coupled with the filter 140 being a strong low-pass filter.
the sequence interference capability for higher harmonics. This classification is relevant for applications in sensitive environments like automotive.

Considering first the power, the sequences can be sorted by increasing or decreasing power to populate a lookup table. A method would be to calculate the Fast Fourier Transform (FFT) of each sequence and sort them using their fundamental amplitude fₒₚ. Empirical methods using measurements could be utilized as well.

Small N factors allow for the population of a lookup table linking a power to a corresponding sequence S₁₃₅ definition with a fine enough resolution to cover the whole operating power range of wireless charger transmitters. FIG. 3C represents an example of a lookup table for N that is equal to 24. Only the 12 bits, corresponding to one of the two half periods is sufficient to reconstruct the full S₁₃₅ sequence.

While N factors as low as 24 may be sufficient to cover the transmission power resolution, adjusting the S₁₃₅ sequences to be spectrally convenient at the same time requires much higher N factors. The higher the N factor the better the approximation of the targeted signal of frequency fₒₚ. For N greater or equal to 92, the spectral signature of the signal satisfies the CISPR25 class 4 limits at 15 W. With N greater or equal to 160, the CISPR25 class 5 limits can be achieved in the same 15 W conditions. However, combining the two goals requires N factors that are greater than 336 to meet the spectral signature and the resolution needed for power levels below 30%.

Practically, on the other hand, the maximum switching frequency f_{sw} becomes a limitation relatively quickly due to the high power switches and pre-driver technology maximum frequency combined with the inherent loss of efficiency resulting from switching a signal at high average switching frequency f_{swa}. For the example of N is equal to 160 for an operation frequency fₒₚ at 127.772 kHz, the maximum H-bridge inverter switching frequency f_{sw} is equal to 20.44352 MHz while the average switching frequency f_{sw}a of several MHz exceeds the capability of standard power MOSFET technology.

With large N sequences, populating a lookup table with the minimum resolution required (usually 512 linear steps for a 15 W transmitter) is a tedious task, the sequences S₁₃₅ needing to be selected to achieve accurately the desired power level and satisfied maximum harmonics level limits. Increasing the factor N simplifies the selection task by increasing the resolution of the signal but also leads to increasingly large memory space for the lookup table. Without consideration of the sequence, increasing N also results in an increase of the switch frequency f_{sw} that is going to generate higher losses.

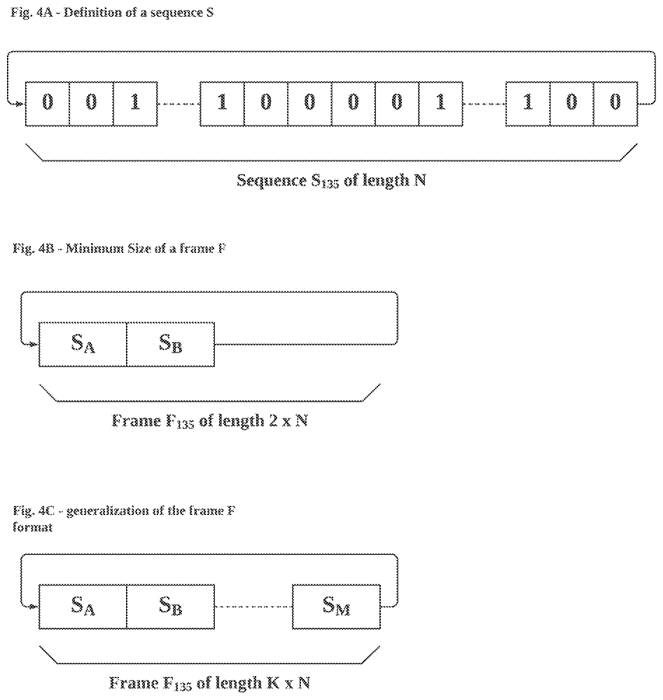

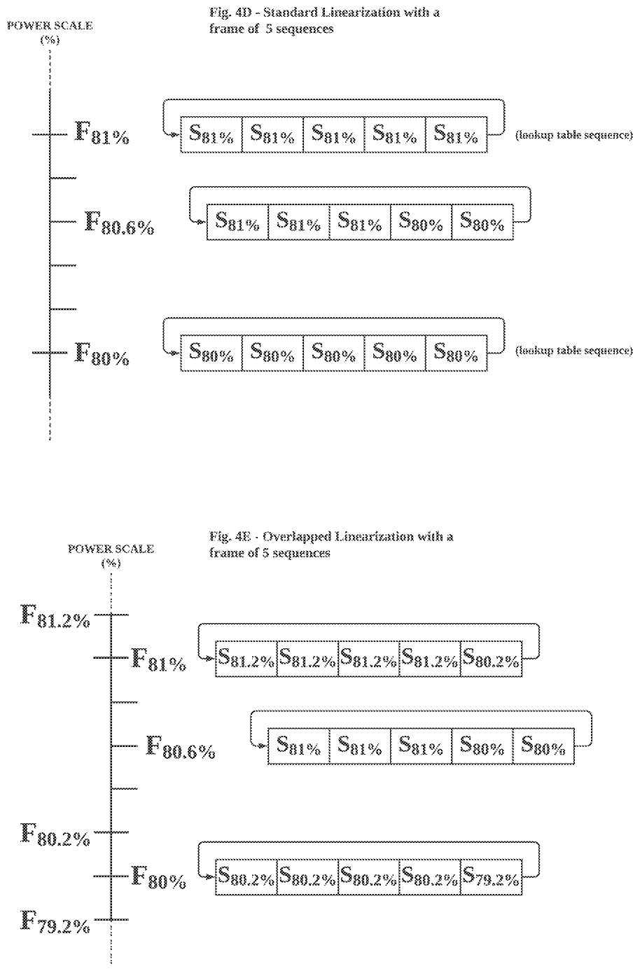

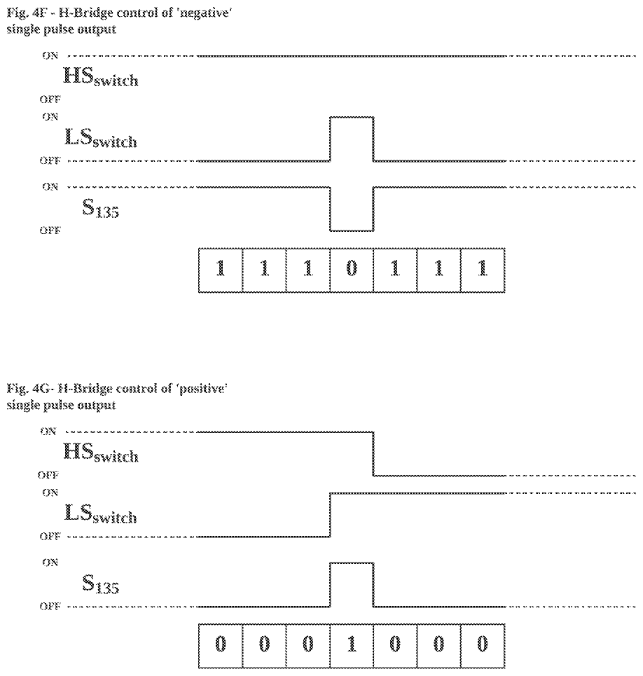

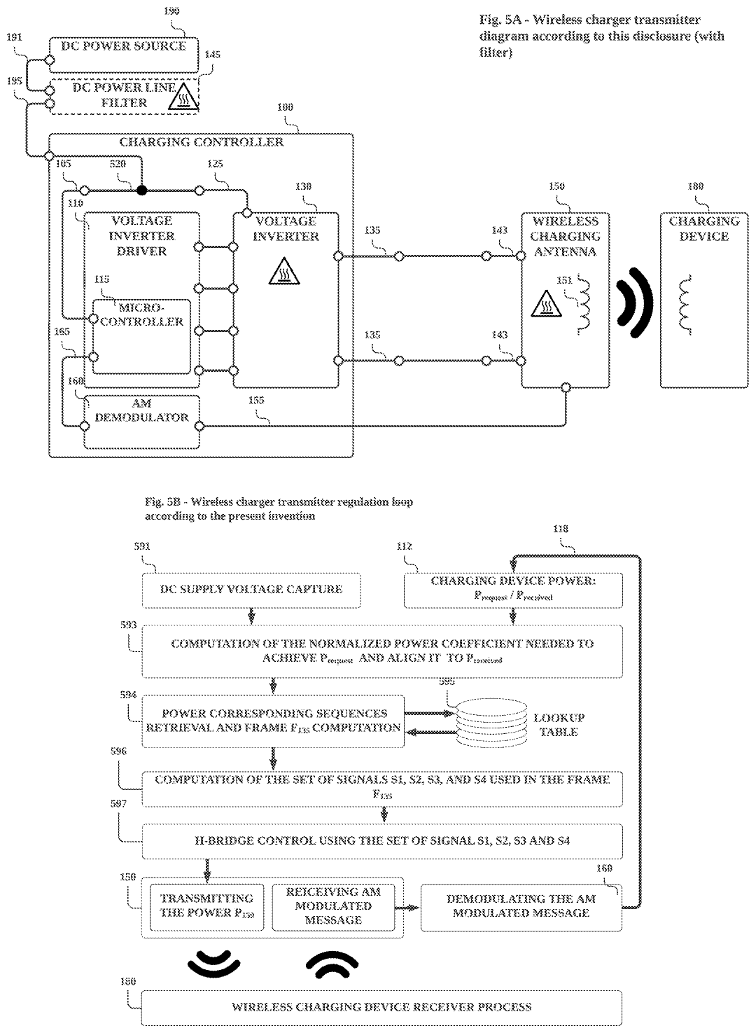

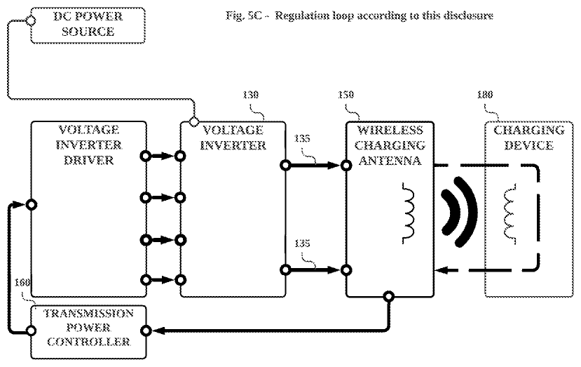

To maximize the efficiency of the voltage inverter 130, this invention proposes to alter the basic operation with the lookup table by introducing linearization between two or more adjacent power levels, significantly reducing the size of the lookup table. The introduction of linearization may provide an opportunity to reduce the minimum size of the N factor, primarily to maximize efficiency. FIG. 4A to 4G illustrate the linearization method.

FIG. 4A represents a sequence S₁₃₅ of length N. The antenna feed signal 135 is generated by repeating the same sequence over at the operation frequency fₒₚ. In that operation mode, the spectral signature and consequently its transmission power is a constant.

FIG. 4B represents the minimum configuration of a frame F₁₃₅. A frame is a period of time comprising a plurality of periods Tₒₚ. The frame F₁₃₅ daisy chains two periods Tₒₚ comprising the sequences S_{A} and S_{B}. Instead of the single sequence S₁₃₅, it is now the frame F₁₃₅ that is repeated over. In frame mode, the spectral signature is the average of the two sequences S_{A} and S_{B}. This averaging applies to the fundamental frequency of the signal and all its harmonics, creating a transmission power control point that is midway between the S_{A} and S_{B} power levels without the need for a dedicated sequence for that particular transmission power to be stored in the lookup table.

Considering the harmonic standpoint, the harmonic amplitudes are also averaged, releasing constraints on the sequence selection: sequences S_{A} and S_{B} that do not strictly satisfy the spectral signature for a certain class of CISPR25 operation may now be used, if the average spectral signature is within the class limits. This is a particularly significant result for systems allowing the cancelation of the requirement for the filters 140 and 145. In the sequence mode, N factors in the range of 160 are required for sequence passing CISPR25 class 5. Using the frame mode, the N factor can be lowered to 112. While there is no single sequence of N equal to 112 that would be strictly compliant to the spectral signature criteria, there are two sequences whose average spectral signature would satisfy that criteria.

FIG. 4C is a generalization of the frame F₁₃₅ concept:
the number of considered sequences may not be limited to the sequences S_{A} and S_{B}. Frames of up to M sequences may be used, where M is an integer. When M is equal to two, the simplest case, the relationship between the lookup table sequences is linear. M greater than 2 implies a M^{th} order polynomial relationship that is usually not very convenient.
the length of the frame can also be extended to a length of K periods using the sequences S_{A} and S_{B}. This would allow the definition of more power steps between two sequences S_{A} and S_{B} while keeping a linear relationship.

The concept of the invention is to provide a frame comprising a plurality of sequences. A sequence comprises a plurality of pulses, and may also be referred to as a pulse sequence. For a frame, at least two different sequences are selected, each providing an associated power level. In embodiments, the sequences are selected from a plurality of available sequences.

In embodiments, the sequences are selected from a lookup table. A count is selected for each sequence, the count being the number of times the particular sequence is repeated within the frame. The average power for the frame is the average power of the sequences, weighted according to the count for each sequence. The sequences and the counts are selected to provide an average power for the frame as close as possible to the requested power level.

In an embodiment, two sequences are chosen, one with a power level higher than the requested power level and one with a power level lower than the requested power level.

In an embodiment, the first sequence to be selected is the one with an associated power level that is closest to the requested power level.

In an embodiment, the second sequence is the next closest, such that, if the first sequence has a power lower than the requested power, then the second sequence will have a power higher than the requested power, and vice versa.

FIGS. 4D and 4E are examples of two linearization techniques.

FIG. 4D represents a portion of the power scale that illustrates a standard linearization algorithm using two sequences S_{80%} and S_{81%} that are stored in the lookup table and are corresponding to 80% and 81% transmission power. Using a five periods frame, the power levels between and including 80%, 80.2%, 80.4%, 80.6%, 80.8% and 81% can be achieved without the need for additional sequences by averaging the output signal power. For example, 80.4% can be achieved by chaining three sequences S_{80%} and two sequences S_{81%} in whatever order. Reaching the endpoints requires the sequences S_{80%} and S_{81%} to be solely used in the frame. To satisfy EMC requirements both sequence spectral signatures have to strictly meet the criteria.

Should we intend to relax the length constraint of N requirements, a double linearization scale is preferable. The principle of that method is illustrated in FIG. 4E. Should the sequences S_{80%} and S_{81%} not be strictly EMC goals compliant, a frame of five identical sequences S_{80%} or S_{81%} will no longer be usable. In that case, a second linearization scale is required to reach the 80% and 81% output signal power steps.

Whatever the linearization method used, it is to note the size of the needed lookup table is drastically reduced. In most cases, 100 to 200 sequences are sufficient.

In an embodiment, the wireless charging controller uses a lookup table and standard linearization algorithm to cover the output signal power range.

In an embodiment, the wireless charging controller uses a lookup table and double linearization algorithm to cover the output signal power range.

In an embodiment, the averaging is limited to six sequences to prevent low frequency oscillations of the signal that may interfere with the downlink load modulation used by the in-charge device to communicate with the transmitter.

In an embodiment, the wireless charging controller decides dynamically the number of sequences K per frame.

In an embodiment, the number of sequences M is equal to two to create a point to point linear control of the signal power. A frame will consequently be constituted by arrangement of two sequences S_{A} and S_{B}. Practically, M larger than two increases the complexity without actual benefits in terms of efficiency.

In an embodiment, the sequences S_{A} and S_{B} are the same length N. This is not however a requirement of the invention. The person skilled in the art would appreciate that the sequences S_{A} and S_{B} could be of different length N_{A} and N_{B}.

As described above, the voltage inverter 130 efficiency is a function of the switching speed which is itself a function of the maximum and average switching frequency f_{sw} and f_{swa}. Mathematically, it can be summarized the following way:

$${Eff}_{130} = f ( {f}_{s w} , {f}_{s w a} ) = f ( {f}_{s w} ( N , {S}_{135} ) , {f}_{s w a} ( N , {S}_{135} ) ) \qquad Equation 2$$

Bringing the voltage inverter 130 to its maximum efficiency comprises lowering N to the minimum needed to reach EMC goals and sufficient resolution to cover the power range in steps that are fine enough for the system to operate as expected by the Wireless Power Consortium Qi standard.

Defining the maximum switching frequency is not as obvious as it seems. Basically, the maximum switching frequency f_{sw} is equal to N times the operation frequency fₒₚ:
if none of the lookup table stored sequences chain consecutively on-off-on state (example 11011b), the maximum switching frequency f_{sw} is equal to N/2 times the operation frequency fₒₚ. FIG. 4F is showing an example of the switch operation for the above mentioned example 11011b. The only way to render the voltage inverter 130 output signal 135 is by switching the high side or low side switch at the maximum frequency f_{sw}.
the opposite case is represented in FIG. 4G and can be, from the switch point of view, be dealt with differently. Although the voltage inverter 130 output signal 135 is a single pulse 00100b, the high side and low side switches can ‘share’ the switching load.

The maximum switching frequency f_{sw} depends only on the number of on-off-on transition arrangements.

In a similar way, the average switching frequency f_{swa} depends on the number of pulses generated during a full operation cycle fₒₚ. Should the number of pulses per cycle be P, the average switching frequency f_{swa} is equal to N/P times the operation frequency fₒₚ. Note that, from an electronics point of view, the voltage inverter is made of four switches and that the four switches are ‘sharing’ the average switching load during the duration of a cycle.

Ultimately, improving the efficiency will require reducing the length N.

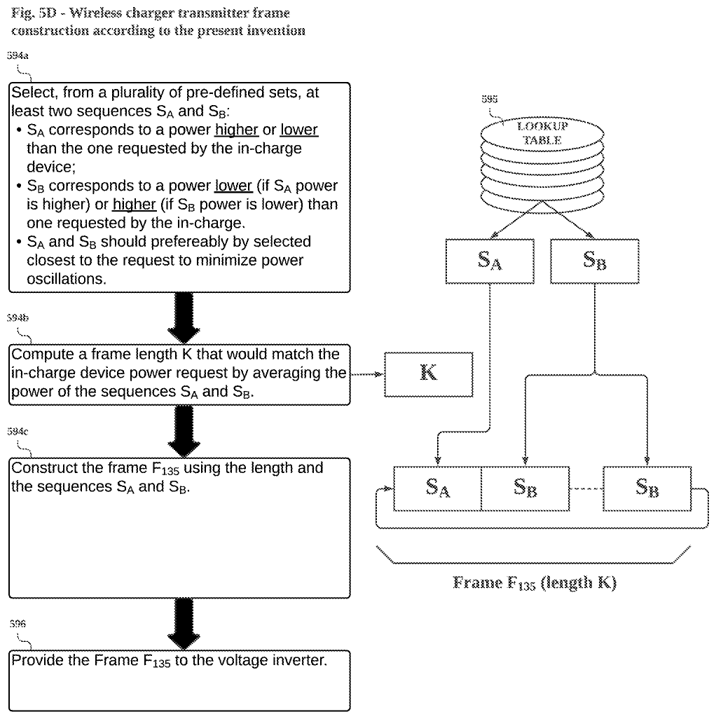

FIG. 5A is a functional diagram illustrating the evolution of the circuit flow chart according to an embodiment. Compared with previous embodiments, the output voltage controlled DC-DC converter 120 has been removed and replaced by a connection 520 connecting the DC input voltage 115 and the voltage inverter input voltage 125:
The DC-DC converter deletion removes the need for the controller 115 control signal 105.
In most applications, the DC input voltage 125 can no longer be considered a fixed and known value by design. The connection 520 is consequently fed back to the microcontroller 115 for monitoring purposes since it enters the computation of the voltage inverter output signal 135.
The filter 140 has been deleted since it is no longer required.
The filter 145 is now optional. In automotive applications, there might still be a need to filter noise on the power lines. In any case the filtering requirements, in embodiments of the invention, are lowered and hence costs are reduced.

In FIG. 5A, the microcontroller 115 controls the energy transmitted to the wireless charging device by altering the shape of the voltage inverter output signal 135 used to feed the wireless antenna 150.

In an embodiment, there is further provided a fixed DC-DC converter, disposed between the DC power source 190 and the voltage inverter 130. This enables the provision of a higher voltage to the voltage inverter 130 than is provided by the DC power source 190 to reach higher transmission powers that may in some cases be needed. Unlike in the state of the art solution, this is a fixed DC-DC converter, providing a fixed ratio of input to output voltage. In an embodiment, the output voltage may be boosted to 15 V. In an embodiment, this may be 18V. The person skilled in the art will appreciate that other output levels may be provided and are within the scope of the invention.

FIG. 5B is a flowchart illustrating a power regulation process of the wireless charging transmitter executed by the microcontroller 115 which may be used with any embodiment. Only the steps relevant to the regulation loop are described. For clarity, the essential functions performed by hardware have been left with their corresponding reference of FIG. 1B. The method comprises:
Capturing the DC supply voltage V_{DC} at step 591.
Obtaining, as per the Qi Standard, the requested power P_{request} and the received power P_{received} from the in charge target device by extracting relevant data from the demodulated signal received from the in-charge device at step 112.
Computing, at step 593, a normalized amplitude Vₙₒᵣₘ using standard electrical circuit calculations. This step may be as simple as:

$$\begin{matrix}( For FIG . 5 A configuration ) & \\ {V}_{n o r m} = \frac{{P}_{150}}{{I}_{150} {V}_{DC}} & Equation 5\end{matrix}$$

Accessing, at step 594, the lookup table 595 to retrieve the sequences needed for the voltage inverter 130 signal output frame F₁₃₅ definition corresponding to the requested power P_{request}.
Calculating the set of switch signal sequences S₁, S₂, S₃ and S₄ needed to generate the sequences used in the frame F₁₃₅ at step 596.
Controlling the voltage inverter 130 using the set of sequences S₁, S₂, S₃ and S₄ at step 597.
Radiating by the wireless charger transmitter the power P₁₅₀ through the wireless charging antenna 150.
Measuring by the in-charge device the received Power P_{received} and broadcasting it back to the transmitter through load modulation.
Demodulating the received message by the AM demodulator 160 and returning to step 112, thus closing the regulation loop.
Responding to the transmitter by accordingly either increasing, decreasing or keeping the same power transmission settings by adjusting the signal output definition F₁₃₅.

FIG. 5C shows the transmission power regulation loop according to embodiments. Unlike in the state of the art solution, it is the voltage inverter 130 that controls the transmission power regulation. This function is realised by adjusting the frames that control the voltage inverter 130. There is no longer a DC-DC converter 120. While the process has been described in FIG. 5B, FIG. 5C shows the loop at the functional level using bolded arrows.

After initialization of the communication between the wireless charging transmitter and the in-charge device 180, the in-charge device 180 acting as the master sends back the received and requested power in a load modulated message (Qi standard). The wireless charger demodulates the message and adjusts the frames to control the voltage inverter signal 135 output power. The sequences used to build the frames are extracted from a lookup table. The antenna 150 are passive in the process: they introduce some losses that are to be compensated by increasing the DC-DC converter 120 output voltage. The wireless charging antenna 150 radiates the power that is partially received and measured by the in-charge device 180, closing the regulation loop.

FIG. 5D represents the process to construct a frame F₁₃₅. It is a close look at the step 594 of the regulation loop in FIG. 5C:
At step 594a, the microcontroller 115 selects two sequences from the lookup table 595, which power encompass the requested power of the in-charge device 180. The two sequences S_{A} and S_{B} are different from each other, with one of the sequences having a power higher than the requested power and the other of the sequences having a power lower than the requested power. The two sequences S_{A} and S_{B} should be preferably selected from a plurality of available sequences to be the sequences with the closest power to the requested power. One of the sequences should have a power higher than the requested power and one lower. This minimizes low frequency power oscillations that may affect the stability of the system communications.
At step 595b, the microcontroller 115 calculates the integer length K of the frame F₁₃₅. The average power of the frame F₁₃₅ should best approximate the power request of the in-charge device.
At step 595c, the microcontroller 115 constructs the frame F₁₃₅ by sequencing the selected frames S_{A} and S_{B} and the length K. To maximize the power oscillation frequency, it is preferable to avoid consecutive sequencing of the same frame.

In an embodiment, a first S_{A}, and a second sequence, S_{B}, are selected from the available sequences, such that they are the sequences which provide power levels closest to the requested power, respectively the closest higher power and the closest lower power. In an embodiment, other sequences may be used, as long as the target power level is in a range between a power level associated with a first power level of the first sequence S_{A} and a second power level of the second sequence S_{B}. A plurality of sequences is selected from amongst the sequences in the look-up table and a respective count is selected for each of the plurality of sequences, such that a sum of the product of each of the sequences' power levels and its respective count is equal to a power level within the range.

The removal of the DC-DC converter 120 means that the loss that such a device normally causes is now absent. This enables a 5 to 7% efficiency credit to the system. Some of this credit is lost in the voltage inverter 130 due to the higher average switching frequency of the voltage inverter switches. The balance is, however, largely positive.

The format of the lookup table may vary depending on the type of symmetry used for the sequences and the hardware driver used to generate the signal:
Should the sequence be π symmetrical, a single quadrant of N/4 bits is sufficient to fully characterize the sequence.
The type of linearization (standard, double or polynomial) induces the numbers sequences to be stored in the lookup table.

Step 516, relative to the computation of the signal sequences S₁, S₂, S₃ and S₄, consists in computing the four voltage inverter 130 switch control sequences S₁, S₂, S₃ and S₄ and the frame constitution needed to generate the requested power P_{request}. In most cases, this can be done easily by bit manipulation.

In an embodiment, the sequence update in step 112 is synchronized with the operation frequency fₒₚ period to avoid a phase shift that may interfere with the frequency modulation communication towards the in-charge device.

Switching a power signal at such a high frequency f_{sw} presents challenges that will be addressed below.

Despite being microcontroller friendly, the construction of a pseudo sine or pseudo trapezoid signal using a Pulse Width Modulation presents, in this case, four challenges that are related to the high switching frequency f_{sw}:
Inexpensive microcontrollers are clocked at a frequency only a couple of times higher than the frequency f_{sw} preventing direct control of the Pulse Width Modulation.
The four signals controlling the voltage inverter 130 power switches 131 to 134 need to be perfectly synchronized to ensure that no short is created between the DC power source 190 and the ground GND.
According to the Wireless Power Consortium Qi standard version 1.3, a Frequency Shift Keying FSK modulation is to be used to communicate with the in-charge device.

This modulation can only be implemented by modulating the frequency f_{sw}, making it even harder to do with a microcontroller directly controlled Pulse Width Modulation signal.
Though theoretically achievable, MOSFET technology can be used only with great difficulty above 5 MHz due to the switching losses involved. In most cases, the use of Gallium Nitride technology is recommended.

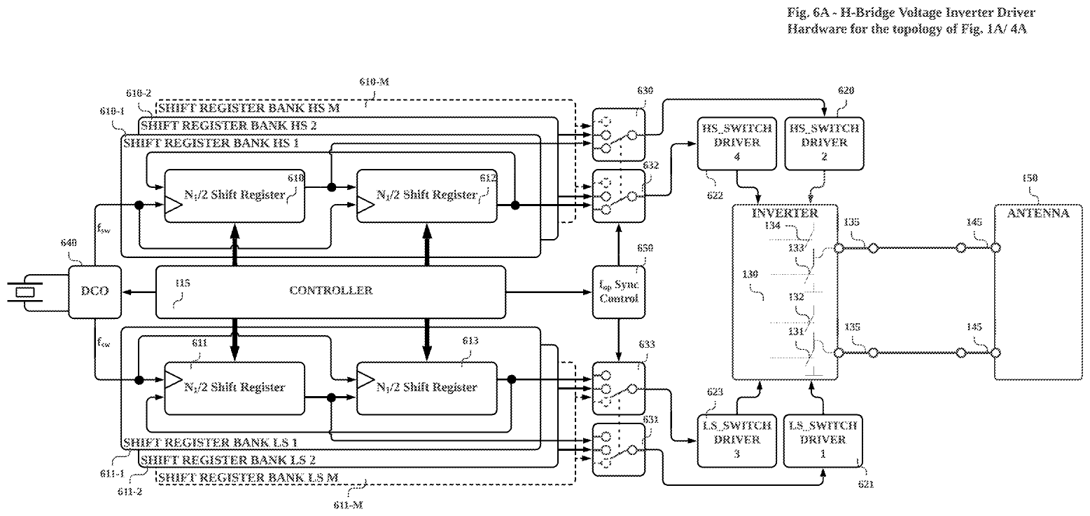

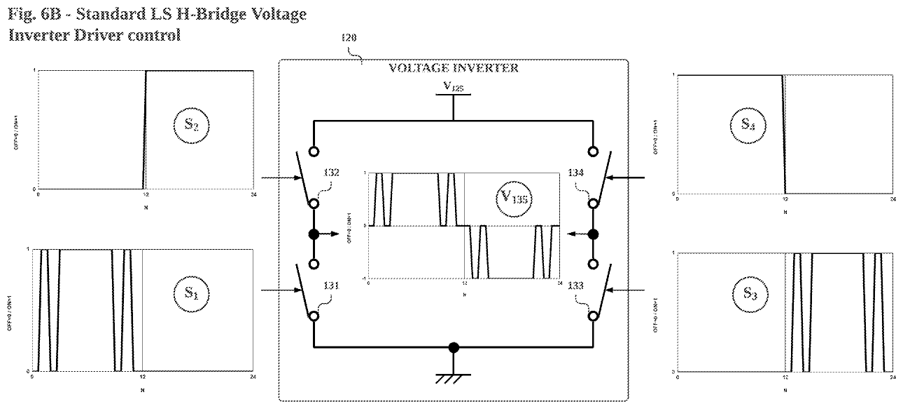

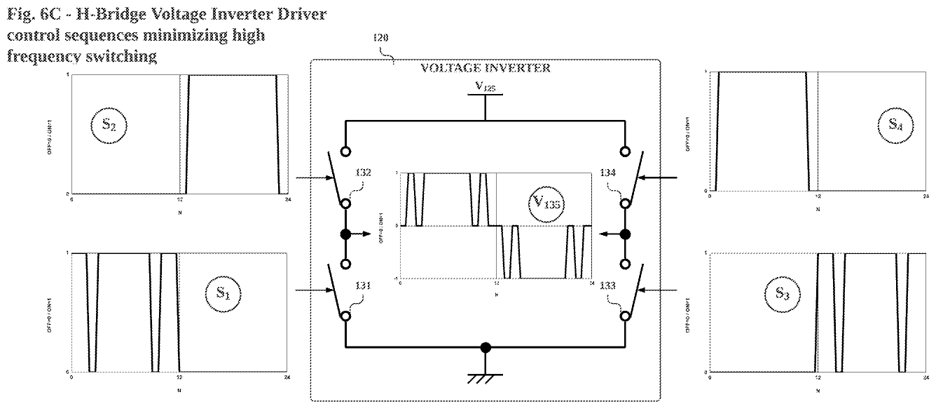

A solution to these problems is proposed in the embodiment of FIG. 6A. FIG. 6A is a schematic diagram according to embodiments. Modification of the state of the art diagram shown in FIG. 1A are illustrated. According to the embodiment of FIG. 6A, there is provided an H-bridge voltage inverter driver that is suited to any definition of the voltage inverter 130 output signal 135 using a single frequency f_{sw}.

The diagram comprises six main functional blocks:
Two pairs of high side and low side switch drivers 620, 622, 621 and 623 that control the switching of the voltage inverter high side and low side switches. The voltage inverter switches being usually either MOSFETs or GaN FETs or a combination of both technologies, suited interfaces are needed to drive them correctly.
Two pairs of synchronized switches 630, 632, 631 and 633 that are used to assemble the frames F₁, F₂, F₃ and F₄. Each switch has as many inputs as the number of sequences needed to build the frame and one output that is connected to one of the high side or low side drivers 620, 622, 621 and 623 input.
A switch synchronizer 650 that controls the switching of the synchronized switches 630, 632, 631 and 633. The switching time is synchronized to the wireless charger operation frequency fₒₚ to avoid phase shifting that would interfere with the uplink communication with the in-charge device 180 and also prevent power surges. In an embodiment, this function is done using the microcontroller 115 using internal counters. In another embodiment, external counters or dividers may be used.
To generate the sequences, the voltage inverter driver is fitted with pairs of rotating shift register banks, each register bank controlling two of the four voltage inverter 130 signals S₁, S₂, S₃, and S₄. In FIG. 6A, the bank 610-1 is used for the control of the high side switches with the sequences S₂ and S₄ and the bank 611-1 for the control of the low side switches with the sequences S₁ and S₃. A second pair of banks 610-2 and 611-2 is needed for the minimum system to ensure that power transitions are made synchronously to the operation frequency fₒₚ cycle. Additional pairs of banks up to 610-M and 611-M are optional, should more than two sequence definitions be used to define the periodic frames F₁, F₂, F₃ and F₄ that control the voltage inverter switches. The detailed operation of a shift register bank is detailed below.
A clock generator 640 clocks the system center on the switching frequency f_{sw}. The switching frequency fsw is configurable to frequency modulation according to the Wireless Power Consortium Qi standard.
A microcontroller 115 controls the system by:
   selecting the sequences to be used in frames and initializing timely the shift register banks 610-1 to 611-M.
   switching the synchronized switches 630, 632, 631 and 633 according to the frame plan made of a sequence count and a frame length.
   controlling the clock generator 640 to superpose the frequency modulation FM used to communicate with the in-charge device 180.

A more detailed description of the shift register bank 610-1 to 611-M is provided below using the first pair of shift register banks 610-1 and 611-1:
Two of a pair of n bits shift register sub banks 610-612 and 611-613, each pair being dedicated to the control of two switch drivers 620-622 and 621-623.
The serial output of the n bits shift register 610 is connected in daisy chain to the serial input of the n bits shift register 612 to build a N bits shift register where N is equal to 2 times n corresponding to the resolution of the desired Pulse Width Modulation signal. The output of the n bits shift register 612 is connected to the input of the n bits shift register 610 to form a N bits rotary shift register. Additionally, the serial output of the n bits register bank 610 is used to control the high side switch driver 620 and the serial output of the n bits register bank 612 is used to control the high side switch driver 622.
In the same way, the serial output of the n bits shift register 611 is connected in daisy chain to the serial input of the n bits shift register 613 to build a N bits shift register where N is equal to 2 times n corresponding to the resolution of the desired Pulse Width Modulation signal. The output of the n bits shift register 613 is connected to the input of the n bits shift register 611 to form a N bits rotary shift register. Additionally, the serial output of the n bits register bank 611 is used to control the low side switch driver 621 and the serial output of the n bits register bank 613 is used to control the low side switch driver 623.
The microcontroller 115 initializes the n bits shift registers 610 to 613 with sequences of bits S₂, S₁, S₄ and S₃ respectively, prior to any charging activity. In the example of FIG. 6A, parallel programming was chosen as the simplest possible way using commercially available logic gates. This programming step, to be done at initialisation, will store the desired Pulse Width Modulation signal definition in the N bits register banks.
The microcontroller 115 also controls the shifting frequency of N bits registers through a Voltage Controlled Oscillator 640 whose baseline frequency is the switch frequency f_{sw} 630. It is necessary to implement the frequency shift key modulation needed for communication towards the in charge target device 180.
Each switch driver 620 to 623 is in turn controlling the switch state of the voltage inverter 130 switches 131 to 134.

FIGS. 6B and 6C are part schematic and part graphical diagrams illustrating possible N bits shift register bank configurations for generating the expected voltage inverter 130 Pulse Width Modulation (PWM) output signal using the positive/negative symmetry organization described in FIG. 5A. There are several possible sequence combinations S₁, S₂, S₃ and S₄ for a single N bits signal definition. For N equal to 24 and n equal to 12, the simplest option is illustrated in FIG. 6C:
In the following description, a bit set to 1 turns on the switch and a bit set to 0 turns the switch off.
The n bits shift register pair 611 and 613 control the low side switches of the voltage inverter 130. The n bits shift register 611 is initialized by the microcontroller 600 with the hexadecimal 5FAh and the n bits shift register 613 with the hexadecimal value 000h.
The n bits shift register pair 610 and 612 control the high side switches of the voltage inverter 130. The n bits shift register 610 is initialized by the microcontroller 600 with the hexadecimal value 000h and the n bits shift register 612 with the hexadecimal value FFFh.
When the N register shift banks are enabled, the voltage inverter switches are driven as shown in FIG. 6C and generate the voltage inverter output signal 135.

In this embodiment, the high side switches 132 and 134 operate the same way as in the state of the art solution. They can consequently use the same switches i.e. MOSFETs, and the same high side MOSFETs drivers. The low side switches, however, are switched at much higher frequencies to generate the requested Pulse Width Modulation signal. These high frequencies are likely, depending on the discretisation factor N, to force the use of switches that can operate at higher frequencies with lower losses and less distorted signal outputs, such as Gallium Nitride FET (GaNFETs).

A more complex but preferable embodiment is illustrated in FIG. 6C. This solution is technically better due to its ability to split the switching losses between the high side and low side switches, reducing the thermal losses caused by switching. It may, for lower values of N, allow the use of MOSFETs for both high side and low side switches:
The state of the voltage inverter 130 halves is defined by both switch states: should any of the high side or low side switch be off-state, the bridge will be turned off. To be on state, both switches have to be turned on.
The n bits shift register pair 611 and 613 controls the low side switches of the voltage inverter 130. The n bits shift register 611 is initialized by the microcontroller 600 with the hexadecimal value 7FEh and the n bits shift register 613 with the hexadecimal value 000h.
The n bits shift register pair 610 and 612 controls the high side switches of the H-bridge inverter 130. The n bits shift register 610 is initialized by the microcontroller 600 with the hexadecimal value 000h and the n bits shift register 612 with the hexadecimal value DFBh.
When the N register shift banks are enabled, the voltage inverter switches are driven as shown in FIG. 6C and generate the voltage inverter output signal 135.

The above hexadecimal value of 5FAh is given as a static example of signal reconstruction to illustrate the operation of the configurations illustrated in FIG. 6A using the voltage inverter control method of FIGS. 6B and 6C, according to an embodiment. The same sequence reconstruction method can be used for any value stored in the lookup table of FIG. 5C and in a larger scope, any hexadecimal value with the same number of bits N.

The person skilled in the art will appreciate that the hexadecimal values are provided as an example only and the invention is not limited to these specific values.

1. A charging controller for a wireless charging transmitter, the charging controller comprising a voltage inverter with output terminals electrically connectable to an inductive wireless charging antenna and configurable to operate the voltage inverter at a nominal switching frequency, fₒₚ, the nominal switching frequency having an associated period, Tₒₚ, wherein the charging controller is configured to supply to the output terminals a frame comprising at least two periods, wherein, in the first period, the controller is configured to supply a first sequence, S_{A}, and in the second period, the controller is configured to supply a second sequence, S_{B}, and wherein the first sequence, S_{A}, is different from the second sequence, S_{B}.

2. A charging controller according to claim 1, wherein the frame comprises K periods, Tₒₚ, K being an integer greater than 1, and the charging controller is configured to supply, for each of the respective K periods a respective sequence, S_{A}, or, S_{B}.

3. A charging controller according to claim 2, wherein the respective sequences are selected from a predefined set of M sequences, wherein M is less than or equal to K.

4. A charging controller according to claim 1, wherein the sequences are selected from a look-up table.

5. A charging controller according to claim 4, further configured to:
receive a target power level;
select from the look-up table:
the first sequence, S_{A}, and the second sequence, S_{B}, the sequences being selected such that the target power level is in a range between a power level associated with a first power level of the first sequence S_{A} and a second power level of the second sequence S_{B}, the sequences being selected from amongst the sequences in the look-up table; and
select a respective count for each of sequences, such that a sum of the product of each of the sequences' power levels and its respective count is equal to a power level within the range.

6. A charging controller according to claim 5, wherein the first sequence, S_{A}, is a sequence from a plurality of sequences in the look-up table with a power level closest to the target power.

7. A charging controller according to claim 5, wherein the plurality of sequences consists of the first and second closest sequences S_{A} and S_{B}.

8. A charging controller according to claim 5, wherein the second closest sequence, S_{B}, is a sequence from the plurality of sequences in the look-up table with a power level second closest to the target power.

9. A charging controller according to claim 4, wherein the lookup table lists sequences sorted by a fundamental frequency, fₒₚ, power.

10. A lookup table according to claim 4, wherein the selected sequences are characterized by a spectral signature equivalent to a square wave spectral signature of a same fundamental frequency, fₒₚ, with harmonics attenuated in the AM-band.

11. A charging controller according to claim 1, wherein the voltage inverter driver further comprises a microcontroller for controlling a wireless charging operation by controlling the voltage inverter based on the received data from a target device through an amplitude demodulator circuit.

12. A charging controller according to claim 1, further comprising a DC-DC converter, configured to receive power from the DC power source at a first voltage and provide power to the voltage inverter at a second voltage, the second voltage being higher than the first voltage.

13. A method of operating a charging controller for a wireless charging transmitter, the charging controller comprising a voltage inverter with output terminals electrically connectable to an inductive wireless charging antenna and configurable to operate the voltage inverter at a nominal switching frequency, fₒₚ, the nominal switching frequency having an associated period, Tₒₚ, wherein the charging controller is configured to supply to the output terminals a frame comprising at least two periods, wherein, in the first period, the controller is configured to supply a first sequence, S_{A}, and in the second period, the controller is configured to supply a second sequence, S_{B}, and wherein the first sequence, S_{A}, is different from the second sequence, S_{B}, the method comprising:
supplying to the output terminals a frame comprising at least two periods, wherein the supplying comprises;
supplying in the first period, a first sequence, S_{A}, and
supplying in the second period, a second sequence, S_{B}
wherein the first sequence, S_{A}, is different from the second sequence, S_{B}.

14. A method of operating a charging controller for a wireless charging transmitter, the charging controller comprising a voltage inverter with output terminals electrically connectable to an inductive wireless charging antenna and configurable to operate the voltage inverter at a nominal switching frequency, fₒₚ, the nominal switching frequency having an associated period, Tₒₚ, wherein the charging controller is configured to supply to the output terminals a frame comprising at least two periods, wherein, in the first period, the controller is configured to supply a first sequence, S_{A}, and in the second period, the controller is configured to supply a second sequence, S_{B}, and wherein the first sequence, S_{A}, is different from the second sequence, S_{B}, wherein the method comprises:
receiving a target power level;
selecting from the look-up table:
the first sequence, S_{A}, and the second sequence, S_{B}, the sequences being selected such that the target power level is in a range between a power level associated with a first power level of the first sequence, S_{A}, and a second power level of the second sequence S_{B};
the sequences being selected from amongst the sequences in the look-up table; and
selecting a respective count for each of sequences, such that a sum of the product of each of the sequences' power levels and its respective count is equal to a power level within the range.

15. A wireless charging transmitter comprising:
a charging system for a wireless charging transmitter, the charging controller comprising:
a voltage inverter with output terminals electrically connectable to an inductive wireless charging antenna and configurable to operate the voltage inverter at a nominal switching frequency, fₒₚ, the nominal switching frequency having an associated period, Tₒₚ, wherein the charging controller is configured to supply to the output terminals a frame comprising at least two periods, wherein, in the first period, the controller is configured to supply a first sequence, S_{A}, and in the second period, the controller is configured to supply a second sequence, S_{B}, and wherein the first sequence, S_{A}, is different from the second sequence, S_{B};
an inductive wireless charging antenna electrically connected to the output terminals of the voltage inverter; and
a DC power source to supply the voltage inverter Driver.

16. A wireless charging transmitter according to claim 15, further comprising:
a low-pass or band-rejection filter installed between the voltage inverter and the inductive wireless charging antenna; and
a power line filter installed downstream the DC power source.
